(19) United States
(12) Patent Application Publication
(10) Pub. No.: US 2012/0140307 A1
(43) Pub. Date: Jun. 7, 2012

(54) Shifting alteration windows

(76) Inventor: Bobby Angel Rodney Freitas, Waianae, HI (US)

(21) Appl. No.: 12/927,980

(22) Filed: Dec. 1, 2010

(51) Int. Cl. B60J 3/00; G02B 5/23

(52) U.S. Cl. 359/241; 296/97.7

(57) ABSTRACT

A special windshield and windows installed to a vehicle for imposing a filter between the interior of a vehicle to include driver and passenger(s) and a source of external sunlight exposed directly to the vehicle. A direct exposure to sunlight will caused windshield and windows to turn darker as a result, the interior of a car will be kept at a low temperature and driver and passenger(s) are not exposed to sunlight. A filter, such as photochromic is imposed between the source of light and the interior of the vehicle. Silver Halide or Silver Chloride is the active ingredients that cause the lenses to darken.

### DESCRIPTION

### Field of the Invention

The invention relates to windshield and windows installed to a vehicle for protecting operators and passengers of vehicle and items in the vehicle. The windshield and windows are made of photochromic materials made of Silver Halide or Silver Chloride. The photochromic windows are not transparent; specifically they filter out UV light. This does not represent a problem because the human eye does not see in the UV spectrum. The windows will begin to clear as soon as they are away from UV light and will be noticeably lighter within two minutes and mostly clear within five minutes. However, it normally takes more than fifteen minutes for the windshield/windows to completely fade to their non-exposed state.

The switching speed of photochromic dyes is highly sensitive to the rigidity of the environment around the dye. As a result, they switch most rapidly in solution and slowest in the rigid environment like a polymer lens.

A study by the Institute of Ophthalmology at the University College London has suggested that even in dark conditions; photochromic windows can absorb up to 20% of ambient light. Ambient lighting can refer to the available light in an environment.

### BACKGROUND OF THE INVENTION

With the many external and internal environmental factors when driving a vehicle, this invention will revolutionize the driving experience. Below depict the many safety and benefits of the invention:

### Safety Feature

Shield your skin from the sun's harmful rays as well as provide a tint for your eyes to see comfortably

Reduce you risks of getting skin cancer and other illnesses cause by excess sun exposure

Reduce the amount of daily sun exposure to your skin

Provide a better driving experience without having to worry about the sun damaging your skin or getting in the way of your eyes

It is initially a lightly tinted window when there is no direct sunlight shining

Auto change to darker shades of tint when detects direct sunlight

Window will darken with the more light shining

Steady and smooth, yet immediate, transition from a light to dark tint

Depending on the brightness of the sun (light) is dependent on the darkness of the transition to tint (will not surpass illegal darkness of tint allowed by law)

The less light shining, the less the tint transition will be; until there is little or no light will the glass window turn back to its initial light tint

Less distractions, more attention on the road

Hands can always be on the steering wheel

No need for unnecessary movement to block your face from the sun

It will play as a better alternative to regular tinted cars

Gives the stylish appearance of (any) tinted car, where transition windows will provide a tint when needed and/or is necessary

Good alternative for those who wear sunglasses while driving, or those who do not wear sunglasses

Provide as a new revolutionary feature to cars that is worry free and safe

Reduces the heat within the car that heats the interior (if you do not use a reflector)

### BENEFITS

### Infants

Skin protection

Sun shielding screens that stick on the inside car windows will no longer be necessary

### Sunscreen

Applying sunscreen religiously is time consuming

Global warming

Climate is hotter

Need for skin protection is higher

Higher risks of skin cancer

### Policemen

It can be easier at night time for police to look into cars when looking for suspicious activity

Criminals or people that have windows that are too dark to see through (at night)

### BRIEF DESCRIPTION OF THE DRAWING

The following drawing is illustrative of the invention.

FIG. 1 is an illustrative drawing of the transformation of a vehicle's windshield and windows as it come in contact with direct sunlight. The drawing depicts the windshield and windows turning from regular lenses to dark tint.

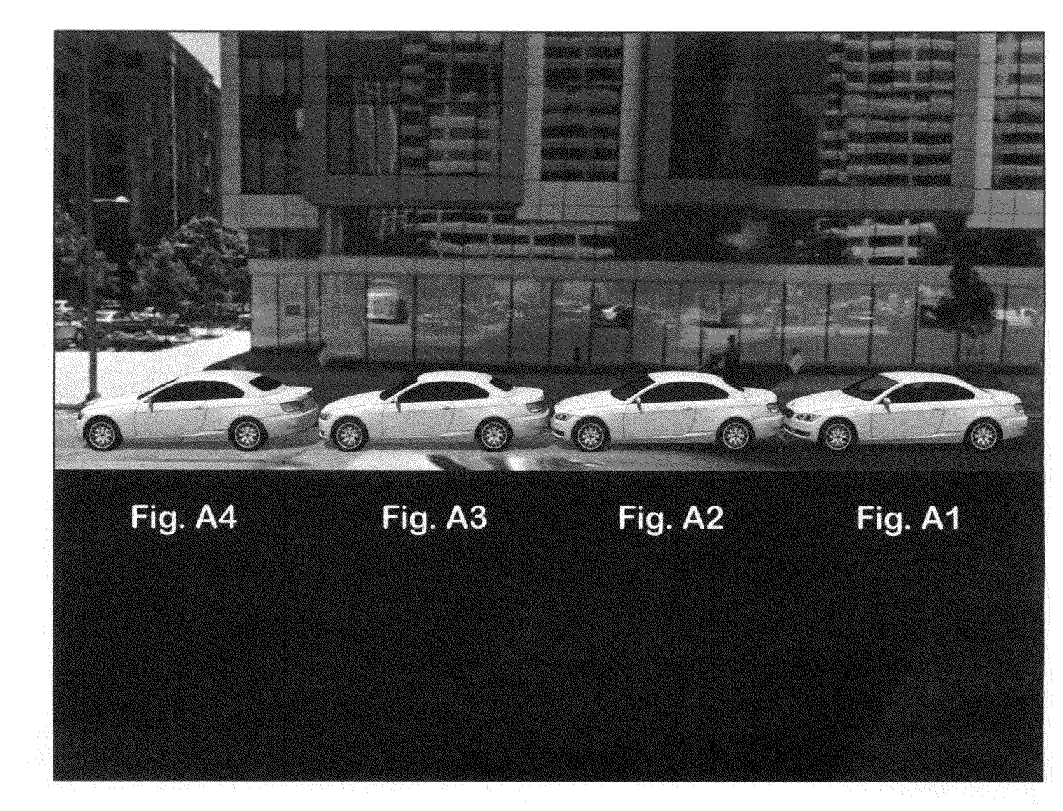

What is claim are:

1. Windshield and windows installed to a vehicle that will filter direct sunlight; thus, preventing the vehicle driver's & passenger(s)' body (to include the interior of a car) from exposure to sunlight. Filter means windshield and windows are especially made with materials to filter sunlight.

2. The windshields and windows of claim 1, wherein said filter means comprise of a photochromic windshield and windows.

3. The windshield and windows of claim 2, wherein said photochromic means the ability to turn from dark tint to light tint of the said windshield and windows.

4. The photochromic of claim 3, wherein said ability mean the photochromic is made of Silver Halide or Silver Chloride and it's mixed throughout the window. This will make the entire windshield and windows of a vehicle to change color when exposed to (sun)light.
